(19) United States
(12) Patent Application Publication
(10) Pub. No.: US 2011/0140515 A1
(43) Pub. Date: Jun. 16, 2011

(54) Work Platform Vehicle

(75) Inventors: Toshiyuki Mabashi, Tokyo (JP); Yuki Kominato, Tokyo (JP)

(73) Assignee: FUJI JUKOGYO KABUSHIKI KAISHA, Tokyo (JP)

(21) Appl. No.: 12/955,536

(22) Filed: Nov. 29, 2010

(30) Foreign Application Priority Data
Dec. 11, 2009 (JP) 2009-281145

(51) Int. Cl. B60L 1/00

(52) U.S. Cl. 307/9.1

(57) ABSTRACT

The object of the present invention is to provide a work platform vehicle having an engine drive system and an electric power drive system as the drive system for a work apparatus, which prevents its engine starting battery from becoming dead when driving the work apparatus with electric power and protects both the engine starting battery and its work battery. In an electric circuit installed in the work platform vehicle, when the engine is selected by a power selection switch that switches the power to the work apparatus, electric power is supplied to control systems S, C and C from the engine starting battery, and the electric power supply to the control systems from the work battery is cut off, and when electric operation is selected, electric power is supplied to the control systems from the work battery, and the electric power supply to the control systems from the engine starting battery is cut off.

### CROSS REFERENCE TO RELATED APPLICATIONS

This application claims priority under 35 U.S.C. 119 based upon Japanese Patent Application No. 2009-281145, filed on Dec. 11, 2009. The entire disclosure of the aforesaid application is incorporated herein by reference.

### FIELD OF THE INVENTION

The present invention relates to a work platform vehicle that comprises a work apparatus and an engine drive system and electric power drive system as the drive systems thereof.

### BACKGROUND OF THE INVENTION

As is well known, currently various kinds of vehicles are used as work platform vehicles. Here, a work platform vehicle is a vehicle on which a work apparatus is mounted on the vehicle, and work (operation other than driving of the vehicle) is performed using that work apparatus. Hydraulic drive type apparatuses are widely used as a work apparatus.

A type of drive system that comprises an engine drive system and electric power drive system as a system that drives the rotation of a hydraulic pump of a hydraulic-drive type work apparatus is disclosed for example in Japanese Patent Application Publication Nos. H10-37904, 2003-146600, 2005-329871, 2002-104772, H3-112727 and H10-087295. In an engine drive system that uses the engine for driving the vehicle, a PTO (Power Take-Off) apparatus is used for extracting power from the engine in order to perform other work that is not driving the vehicle.

For example in Japanese Patent Application Publication Nos. H10-37904, 2003-146600, 2005-329871, 2002-104772, and H3-112727, an engine/PTO apparatus system and battery/electric motor system are disclosed as a system that rotates and drives a hydraulic pump of a work apparatus.

The invention disclosed in Japanese Patent Application Publication No. 2005-329871 is configured such that an engine drive drives a hydraulic pump via a power take off apparatus (PTO apparatus), and this hydraulic pump causes a garbage pickup apparatus to operate, where the hydraulic pump can also be driven by an electric motor that is mounted in the vehicle separate from the engine drive, such that the hydraulic pump can be driven by using both or one of the engine drive or electric motor drive.

In the invention disclosed in Japanese Patent Application Publication No. H10-087295, when operating a work apparatus using an electric motor, the vehicle batter automatically starts the engine when the voltage of the electric motor drops and causes a crankshaft direct-coupled type generator to generate electric power. This generated electric power drives the electric motor, as well as recharges the vehicle battery. Also, in the invention disclosed in Japanese Patent Application Publication No. H10-087295, a work apparatus control unit that sends switching signals to various switching valves of the work apparatus is driven by the electric power from the vehicle battery.

However, the conventional technology had the following problems.

In a conventional work platform vehicle that comprises both a engine drive system and electric motor drive system, or in a conventional work platform vehicle that comprises only an engine drive system, when the engine drive system is used to drive the work apparatus by the driving force from the engine for driving the vehicle, the control system for the work apparatus receives an electric power supply from an engine starting battery. When doing this, this engine for driving the vehicle rotates the generator and recharges the engine starting battery. Therefore, there is little possibility for a dead battery.

On the other hand, in a conventional work platform vehicle comprising both an engine drive system and electric power drive system, when using the electric power drive system to drive to work apparatus, the control system of the work apparatus receives an electric power supply from the engine starting battery. In this case, normally, when the engine for driving the vehicle is operating, silent operation that is obtained by using the electric motor drive is not maintained, so the engine for driving the vehicle is stopped. By doing so, the engine starting battery is not recharged, and power continues to be discharged. Therefore, there is a possibility that the battery will become dead. In the case that the battery becomes dead, the engine for driving the vehicle cannot be started, and it become impossible to drive the vehicle and drive the work apparatus using the engine drive system.

In order to solve this problem, it is possible to avoid the engine starting battery becoming dead by affixing the power supply for the control system of the work apparatus to a work battery. However, at the instant when the remaining electric power in the work battery is low, there is no enough electric power for the control system of the work apparatus to switch over to the engine drive. Consequently, it becomes impossible for the engine drive system to drive the work apparatus.

The aforementioned problem cannot be solved even when those batteries installed in the vehicle are modified to only one battery.

Arranging the engine starting battery and the work battery in parallel and supplying electric power to the control system of the work apparatus from both batteries is also not a solution to the aforementioned problem. Furthermore, a problem of battery degradation due to distributing power simultaneously on the same line from different types of batteries becomes a concern.

Taking the aforementioned problems of the prior art into consideration, the object of the present invention is to provide a work platform vehicle having an engine drive system and an electric power drive system as the drive system for a work apparatus, which prevents the engine starting battery from becoming dead when driving the work apparatus with electric power and protects both the engine starting battery and the work battery.

### SUMMARY OF THE INVENTION

According to a first embodiment of the present invention for solving the problems described above, there is provided
a work platform vehicle, having an engine and a work apparatus, said work apparatus having an actuator and an electrical control system that controls the actuator, the work platform vehicle comprising:
a first battery used for starting the engine;
a second battery used for the work apparatus and provided separately from the first battery;
a first power transmission system configured to receive power from the engine, and transmit the power to the actuator;
a second power transmission system configured to generate power from the electric power of the second battery, and transmit the power to the actuator;
a switching unit for selectively switch between the first power transmission system and the second power transmission system as the power transmission system that supplies power to the actuator; and
an electric circuit configured to supply or cut off electric power from the first battery and the second battery to the electrical control system;
wherein the electric circuit
supplies electric power from the first battery to the electrical control system and cuts off the supply of electric power from the second battery when the switching unit switches to the first power transmission system; and
supplies electric power from the second battery to the electrical control system and cuts off the supply of electric power from the first battery when the switching unit switches to the second power transmission system.

According to a second embodiment of the present invention, there is provided the work platform vehicle according to embodiment 1, wherein
the first and second batteries have output voltages, those output voltages differing from each other, and the electrical control system has an input voltage;
the work platform vehicle further comprising a converter, wherein the converter converts the output voltage from one or both of the first and second batteries to the input voltage of the electrical control system, and outputs that voltage to the electrical control system.

According to a third embodiment of the present invention, there is provided the work platform vehicle according to embodiment 2,
wherein the input voltage of the electrical control system conforms to the output voltage of one of the first and second battery, and
wherein the converter converts the output voltage of the other of the first and second battery to the input voltage of the electrical control system, and outputs that voltage to the electrical control system.

With the present invention, when the engine for driving the vehicle is selected as the power source for the work actuator, electric power is supplied from the engine starting battery to the control system of the work apparatus, and the supply of electric power from the work battery to the control system is cut off, however, when the work battery is selected as the power source for the work actuator, electric power is supplied from the work battery to the control system, and the supply of electric power from the engine starting battery to control system is cut off.

Therefore, when driving the work apparatus with electric power, the engine starting battery is not used for the work, so there is an advantage in that it is possible to prevent the engine starting battery from becoming dead.

Moreover, the engine starting battery and the work battery do not distribute power to the electric circuit at the same time, so there is an advantage in that it is possible to protect both the engine starting battery and the work battery.

Other features and advantages of the present invention will become apparent from the following detailed description, taken in conjunction with the accompanying drawings, which illustrate, by way of example, the principles of the invention.

### BRIEF DESCRIPTION OF THE DRAWINGS

FIG. 1 is a block diagram illustrating the drive system and internal configuration of a work apparatus of a work platform vehicle of an embodiment of the present invention.

FIG. 2 is an electrical circuit diagram of an embodiment of the present invention.

FIG. 3 is an electrical circuit diagram of an embodiment of the present invention, and illustrates the power distribution state when driving a work apparatus by an engine via a PTO device.

FIG. 4 is an electrical circuit diagram of an embodiment of the present invention, and illustrates the power distribution state when driving a work apparatus by an electric motor.

### DETAILED DESCRIPTION OF THE INVENTION

In the following, an embodiment of the present invention will be explained with reference to the accompanying drawings. The following is only an embodiment of the present invention and does not limit the present invention.

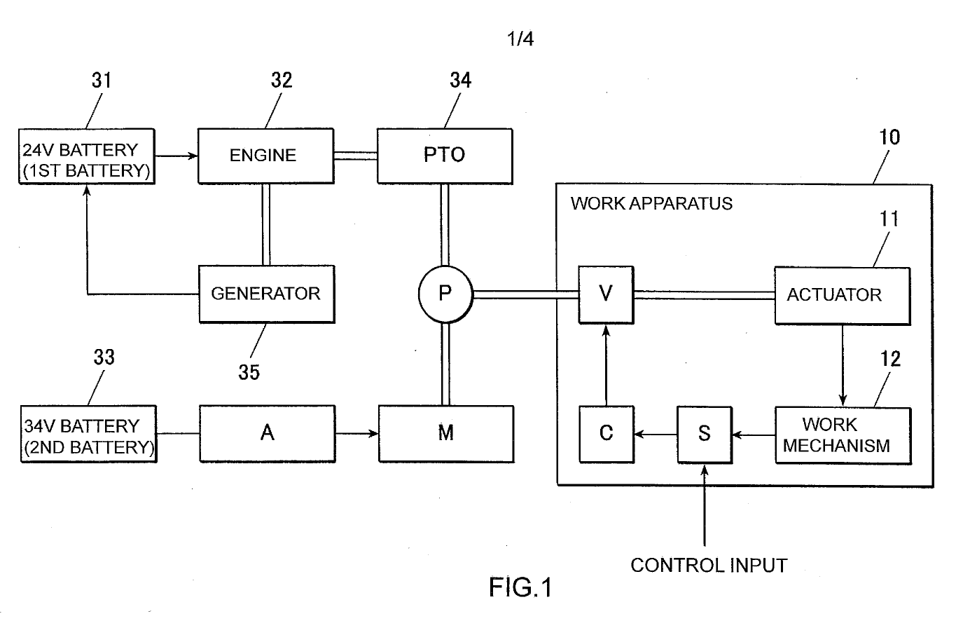

The work platform vehicle of this embodiment, as illustrated in FIG. 1, comprises a 24V engine starting battery 31, which is the first battery according to the present invention, an engine 32 for driving the vehicle, a 36V battery 33 for performing work, which is the second battery according to the present invention, a controller A for controlling a motor, an electric motor M, a PTO device 34, a hydraulic pump P, a generator 35 and a work apparatus 10. The 24V battery 31 is a lead battery that is typically used in vehicles, and in addition to being used to start the engine 32, is a battery used for driving the vehicle and supplies power to electrical equipment necessary for driving the vehicle such as control equipment, display equipment and the like. Generally, in order to accomplish this, the 24V battery 31 is recharged by the generator that is driven by the engine 32. The 36V battery 33 is a lithium-ion polymer battery, for example, and is recharged by an external power supply. The 36V battery 33 can be replaced with a recharged battery, or can be recharged while installed in the vehicle. The electric motor M operates by being controlled by the controller A for motor control, with the 36V battery 33 as a power supply.

In this embodiment, the work apparatus 10 is a hydraulically driven apparatus.

The PTO device 34 extracts power from the engine 32 and rotates and drives the hydraulic pump P, or the electric motor M rotates and drives the hydraulic pump P. The hydraulic pump P feeds pressurized hydraulic fluid to the work apparatus 10. According to the present invention, among the configurations explained below, the system in which the PTO device 34 extracts power from the engine 32 and rotates and drives the hydraulic pump P is defined as the first power transmission system, and the system in which the electric motor M rotates and drives the hydraulic pump P is defined as the second power transmission system. If the work apparatus 10 is not a hydraulically driven type, the above mentioned hydraulic pump is replaced by another power source.

The work apparatus 10 in this embodiment has a work actuator 11 that provides the work force, and control systems S, C, and V that control that work actuator 11.

In this embodiment, the work actuator 11 is a hydraulic actuator such as a hydraulic cylinder, hydraulic motor or the like.

The work actuator 11 performs work by causing a work mechanism 12 to operate. The work mechanism is a movable panel mechanism that loads and compresses garbage in performing garbage pickup work, for example, and in this case, the work actuator 11 causes the movable panel to operate. In addition to this, the work mechanism could also be a crane, a power shovel or the like.

The control system S of the work apparatus 10 comprises switches or sensors, and control system C is a controller for controlling a hydraulic valve. Control system V is a hydraulic valve V. Control system S is installed on the work mechanism 12, and in addition to switches and sensors for detecting the operating state of the work mechanism 12, includes switches or sensors that are operated by an operator such as a start/stop button for starting or stopping work of the work apparatus 10.

The controller of control system C for controlling a hydraulic valve operates according to a detection value from the switches and sensors of the control system S, and controls the feeding and stopping of hydraulic fluid to the work actuator 11 by performing calculations based on a control program, and sends operating instructions to the hydraulic value of control system V for opening or closing the hydraulic valve; where as a result controls the operation of the work mechanism.

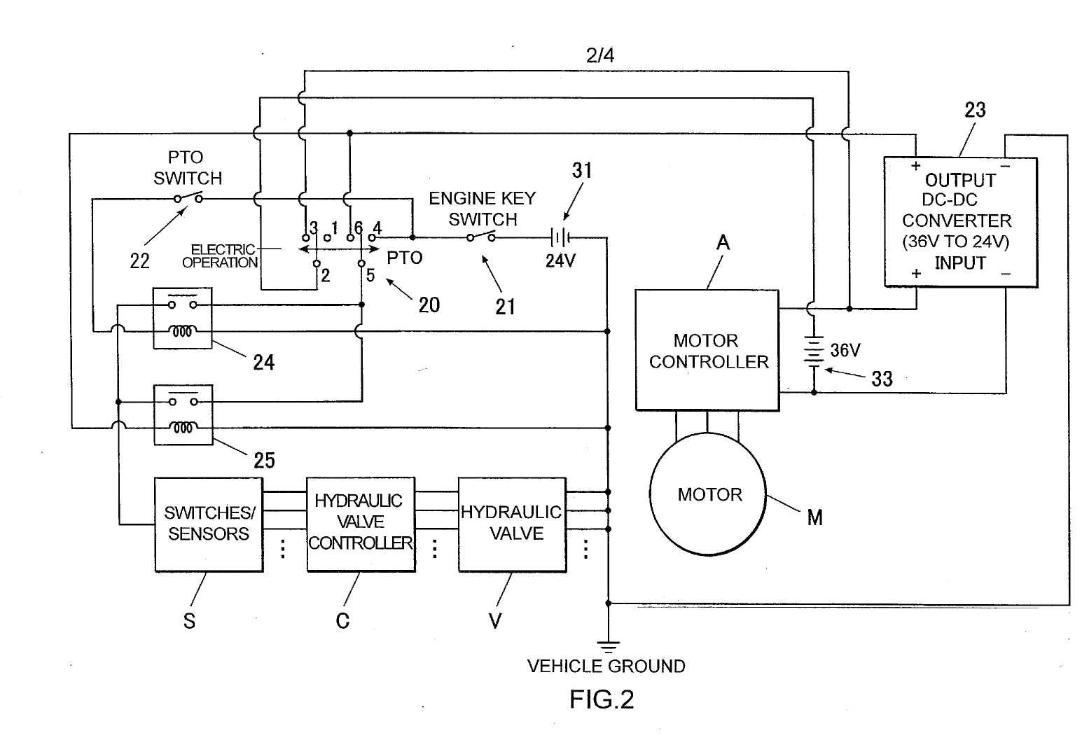

As illustrated in the electrical circuit diagram of FIG. 2, the electrical circuit of this embodiment that includes the 24V battery 31, 36V battery 33, motor M, motor controller A, and control systems S, C and V, further comprises: an electric power/PTO switch 20 that includes a switching unit for switching the power source, an engine key switch 21, PTO switch 22, DC-DC converter 23, first power relay 24 and second power relay 25. The electric power/PTO switch 20, engine key switch 21 and PTO switch 22 are switches that are operated by an operator.

The control systems S, C and V conform to an input voltage of 24V, which is the output voltage from the 24V battery 31.

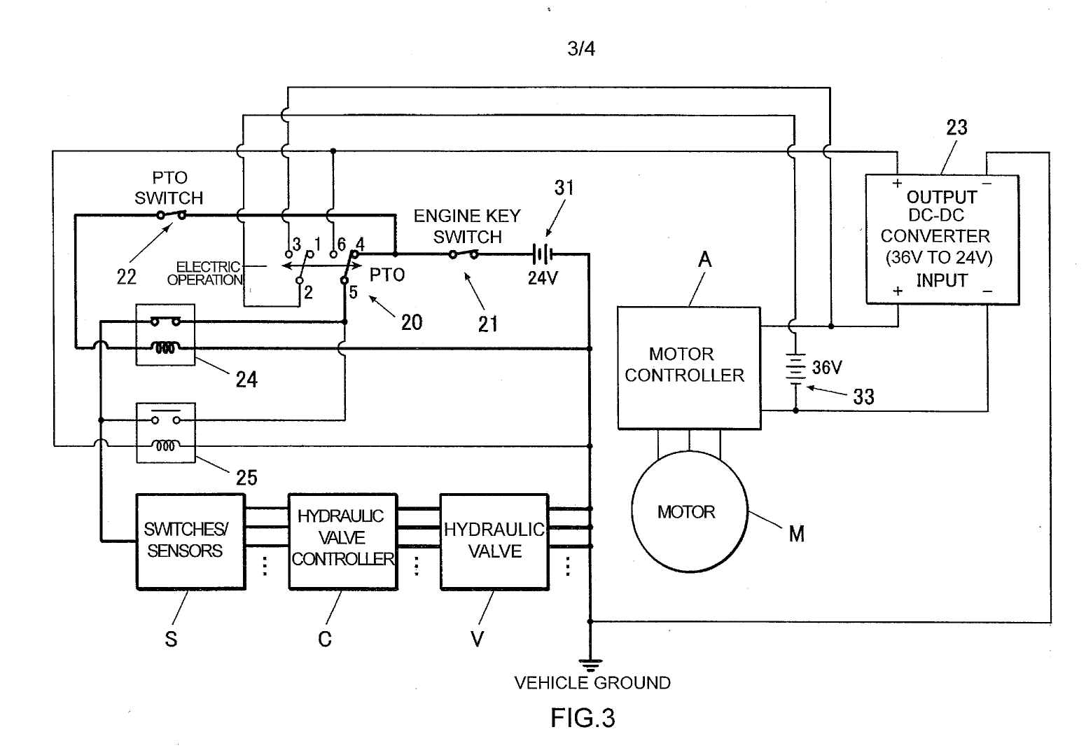

In the construction above, when operating the work apparatus with the power source of the work actuator 11 being the engine 32, that is, when the first power transmission system according to the present invention is selected, the engine key switch 21 and PTO switch 22 are switched to the ON position, and the electric power/PTO switch 20 is switched to the PTO side as illustrated in FIG. 3.

In doing so, contact 5 of the electric power/PTO switch is connected to contact 4. As illustrated in FIG. 3, the voltage from the 24V battery is applied to the first power relay 24 via the engine key switch 21 and PTO switch 22, causing the first power relay 24 to be ON. The second power relay 25 is OFF.

When the first power relay 24 is turned ON, the voltage from the 24V battery 31 is applied to the control systems S, C and V via the engine key switch 21, connection between contact 4 and contact 5 and the first power relay 24. As a result, the section where power is distributed is the section indicated by the bold lines in FIG. 3.

Moreover, when the engine key switch 21 and PTO switch 22 are switched ON, the engine 32 starts, and the hydraulic pump P is driven by power from the engine 32 via the PTO apparatus 34.

In this way, electric power is supplied from the 24V battery 31 to the control systems S, C and V. In other words, when the engine 32 for driving the vehicle is selected through operation of the power-source switching unit as the power source for the work actuator 11, electric power is supplied from the engine starting battery 31 to the control systems S, C and V.

When this happens, contact 2 and contact 3 of the electric power/PTO switch 20 are in the disconnected state, so the 36V battery 33 is disconnected in the circuit. In other words, the supply of power from the work battery 33 to the control systems S, C and V is cut off. In addition, contact 2 and contact 3 of the electric power/PTO switch 20 are in the disconnected state, so power is not distributed to the motor controller A and drive from the motor M is stopped.

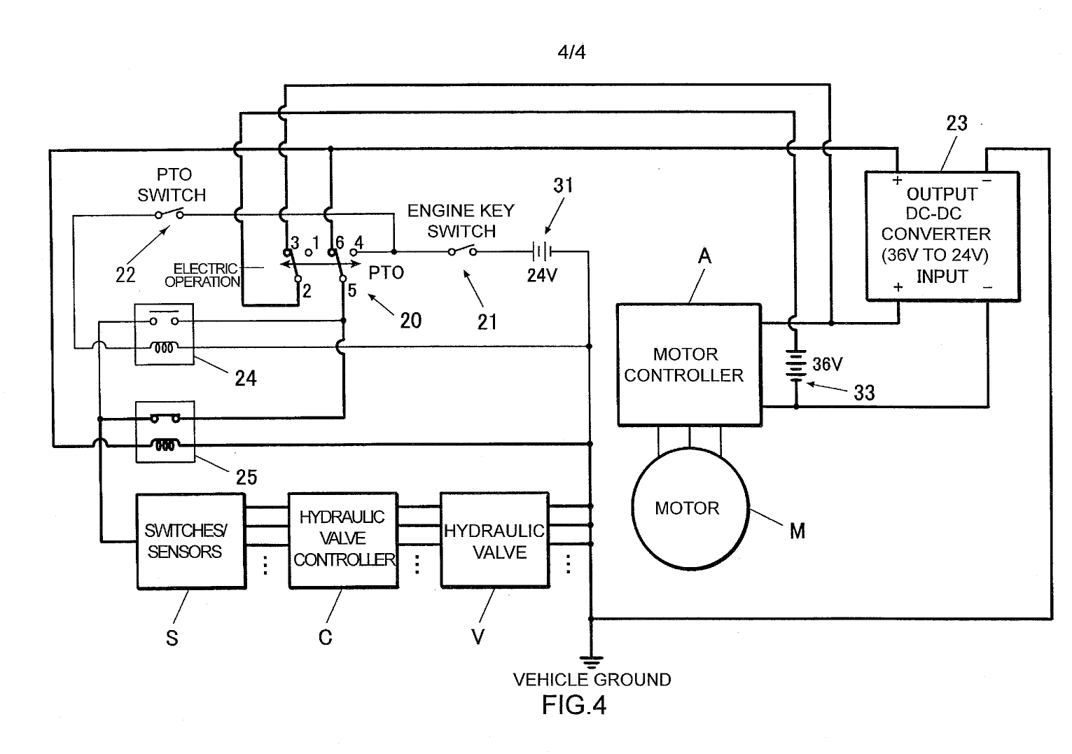

On the other hand, when operating the work apparatus with the 36V battery 33 as the power source for the work actuator 11, that is when the second power transmission system according to the present invention is selected, the electric power/PTO switch 20 is switched to the electric operation side as illustrated in FIG. 4. The engine key switch 21 and PTO switch are switched OFF. By doing this, contact 2 and contact 3 of the electric power/PTO switch 20 are connected, and contact 5 and contact 6 are connected.

In this way, as illustrated in FIG. 4, the voltage from the 36V battery 33 is applied to the motor controller A and DC-DC converter 23 via the connection between contact 2 and contact 3. The electric motor M is able to operate, and the DC-DC converter 23 converts the input 36V voltage to 24V voltage and outputs that voltage.

The 24V output voltage from the DC-DC converter 23 is applied to the second power relay 25, causing the second power relay 25 to go ON. The first power relay 24 is OFF.

By the second power relay 25 being turned ON, the 24V voltage from the DC-DC converter 23 is applied to the control systems S, C and V via the connection between contact 6 and contact 5, and the second power relay 25. As a result, power is distributed to the portions indicated by the bold lines in FIG. 4.

From the above, power from the 36V battery 33 is converted to 24V by the DC-DC converter 23, and that 24V power is supplied to the control systems S, C and V. In other words, when the power switching unit is used to select the work battery 33 as the power source for the work actuator 11, power is supplied to the control systems S, C, V from the work battery 33.

Contact 4 and contact 5 of the electric power/PTO switch 20 are disconnected, so the 24V battery 31 is disconnected in the circuit. In other words, the power supply to the control systems S, C and V from the engine starting battery 31 is cut off.

With this circuit, when the electric power/PTO switch 20 is switched to the electric operation side, power is not distributed even in the case that the engine key switch 21 and PTO switch 22 are switched ON, so the circuit is safe.

With the work platform vehicle of this embodiment explained above, when driving the work apparatus 10 by electric power, the engine starting battery 31 is not used, so it is possible to prevent the engine starting battery 31 from becoming dead.

Moreover, the engine starting battery 31 and the work battery 33 do not distribute power to the circuit at the same time, so it is possible to protect both the engine starting battery 31 and the work battery 33.

In the embodiment above, the input voltage to the control systems S, C and V is adjusted to conform to the output voltage from the engine starting battery 31, where the output voltage from the work battery 33 is converted by the converter 23 to conform to the input voltage to the control systems S, C and V and outputted to the control systems S, C and V. Regardless of this, the input voltage to the control systems S, C and V can be adjusted to conform to the output voltage from the work battery 33, where the output voltage of the engine starting battery 31 is converted by the converter to conform to the input voltage to the control systems S, C and V and outputted to the control systems S, C and V.

Moreover, in the embodiment above, the rated output voltage for driving the vehicle and the rated output of the work battery are different, however, even in the case where the rated outputs are the same, the output voltage changes depending on the remaining charge of the battery, so applying the present invention and selectively using both batteries is effective.

Furthermore, in the embodiment above, the work apparatus is a hydraulically driven apparatus, however, the work apparatus is not limited to a hydraulically driven apparatus; for example, taking the work actuator to be an electric actuator such as an electric motor, it is possible to select between the output of a work battery and the output of a generator that is driven by the engine for driving the vehicle, and have an electric type power source to an electric actuator; where in this case as well, applying the present invention and selectively using both a work battery and engine starting battery is effective.

It is to be understood that the above-described embodiments are illustrative of only a few of the many possible specific embodiments which can represent applications of the principles of the invention. Numerous and varied other arrangements can be readily devised by those skilled in the art without departing from the spirit and scope of the invention.

What is claimed is:

1. A work platform vehicle, having an engine and a work apparatus, said work apparatus having an actuator and an electrical control system that controls the actuator, the work platform vehicle comprising:
a first battery used for starting the engine;
a second battery used for said work apparatus and provided separately from said first battery;
a first power transmission system configured to receive power from the engine, and transmit the power to the actuator;
a second power transmission system configured to generate power from the electric power of said second battery, and transmit the power to the actuator;
a switching unit for selectively switching between said first power transmission system and said second power transmission system as the power transmission system that supplies power to the actuator; and
an electric circuit configured to supply or cut off electric power from said first battery and said second battery to the electrical control system;
wherein said electric circuit
supplies electric power from said first battery to the electrical control system and cuts off the supply of electric power from said second battery when said switching unit switches to said first power transmission system; and
supplies electric power from said second battery to the electrical control system and cuts off the supply of electric power from said first battery when said switching unit switches to said second power transmission system.

2. The work platform vehicle according to claim 1, wherein
the first and second batteries have output voltages, the output voltages differing from each other, and the electrical control system has an input voltage;
the work platform vehicle further comprising a converter, wherein the converter converts the output voltage from one or both of the first and second batteries to the input voltage of the electrical control system, and outputs that voltage to the electrical control system.

3. The work platform vehicle according to claim 2,
wherein the input voltage of the electrical control system conforms to the output voltage of one of the first and second battery, and
wherein the converter converts the output voltage of the other of the first and second battery to the input voltage of the electrical control system, and outputs that voltage to the electrical control system.
